(19) United States
(12) Patent Application Publication
(10) Pub. No.: US 2008/0201619 A1
(43) Pub. Date: Aug. 21, 2008

(54) ERROR CORRECTING DEVICE, ERROR CORRECTING METHOD AND DISK SYSTEM

(75) Inventor: Makoto Kosaki, Aichi (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/029,699

(22) Filed: Feb. 12, 2008

(30) Foreign Application Priority Data
Feb. 20, 2007 (JP) 2007-39705

(51) Int. Cl. G06K 5/04

(52) U.S. Cl. 714/699

(57) ABSTRACT

There is provided an error correcting device, including: a demodulation circuit that reads data from an optical disk and demodulates the data to generate demodulated data; a PI syndrome generation circuit that generates a PI syndrome of the demodulated data and outputs the PI syndrome to an external memory; a PO syndrome generation circuit that generates a PO syndrome of the demodulated data and outputs the PO syndrome to the external memory; and an error correcting circuit that reads the PI syndrome and the PO syndrome from the external memory and performs error correction on the demodulated data stored in the external memory, based on the syndromes.

### CROSS-REFERENCE TO RELATED APPLICATIONS

This application is based upon and claims the benefit of priority from Japanese Patent Application No. 2007-039705 filed on Feb. 20, 2007, the entire contents of which are incorporated herein by reference.

### BACKGROUND OF THE INVENTION

1. Field of the Invention

The application relates to error correction.

2. Description of the Related Art

In recent years, a speedup of data read time has been demanded with regard to storage capacities of storage media, such as optical disks increase. However, due to defects while manufacturing optical disks, dirt adhering to the surface of optical disks, or the like, it is difficult to correctly read data from optical disks at high speed. To address this issue, data recorded on such optical disks is recorded together with an error correcting code using the Reed-Solomon product code to restore correct data. Error correction is made based on the error correcting code. Since the processing time of error correction is long, speed-up of the error correction processing is needed to realize speedup of data read time. Speed-up of error correction processing is described, for example, in

### SUMMARY OF THE INVENTION

According to one aspect of an embodiment of the present invention, there is provided an error correcting device, including: a demodulation circuit that reads data from an optical disk and demodulates the data to generate demodulated data; a PI syndrome generation circuit that generates a PI syndrome of the demodulated data and outputs the PI syndrome to an external memory; a PO syndrome generation circuit that generates a PO syndrome of the demodulated data and outputs the PO syndrome to the external memory; and an error correcting circuit that reads the PI syndrome and the PO syndrome from the external memory and performs error correction on the demodulated data stored in the external memory, based on the syndromes.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 is an illustration showing content of a sector of a DVD-ROM;

FIG. 2 is an illustration showing an ECC block of the DVD-ROM of FIG. 1;

FIG. 3 is an illustration showing a coding format of the ECC block of the DVD-ROM of FIG. 1;

FIG. 4 is a block diagram showing an optical disk controller;

FIG. 5 is a block diagram showing an optical disk control device in accordance with embodiments of the present invention;

FIG. 6 is a diagram showing a content of a sector of an HD-DVD usable in accordance with embodiments of the present invention;

FIG. 7 is an illustration showing an ECC block of the HD-DVD of FIG. 6;

FIG. 8 is an illustration showing the ECC block of the HD-DVD of FIG. 6;

FIG. 9 is an illustration showing a coding format of the ECC block of the HD-DVD of FIG. 6;

FIG. 10 is a block diagram showing an optical disk controller in accordance with embodiments of the present invention;

FIG. 11 is a block diagram showing an internal memory in accordance with embodiments of the present invention;

FIG. 12 is an illustration showing an external buffer memory in accordance with embodiments of the present invention;

FIG. 13 is a representative figure for illustrating a read order in a PO direction in accordance with embodiments of the present invention;

FIG. 14 is a flow chart showing operation of error correction in accordance with embodiments of the present invention;

FIG. 15 is a flow chart showing operation of PI error correction in accordance with embodiments of the present invention;

FIG. 16 is a flow chart showing operation of PO error correction in accordance with embodiments of the present invention; and

FIG. 17 is a block diagram showing an optical disk controller.

### DESCRIPTION OF THE PREFERRED EMBODIMENTS

An error detecting code (EDC) for detecting errors that occur when reading data recorded in a recording medium (CD, DVD, HD-DVD, etc.) is attached to the data in advance of error correction activity. Also, an error correcting code (ECC) for correcting errors that occur when reading data is attached to the data in advance.

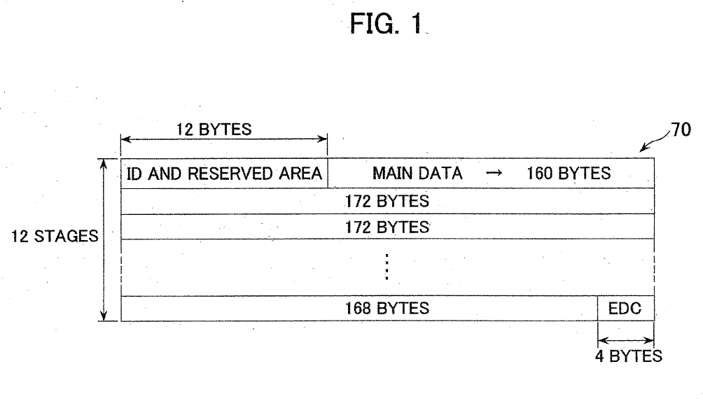

For example, FIG. 1 shows an exemplary format for data stored in a DVD-ROM. One sector 70 is constituted as 12-stage data in the row direction (e.g., in the horizontal direction as shown in FIG. 1) with 172-byte data in each stage. In the initial stage, a 12-byte ID and reserved area, as well as 160-byte main data are stored. In the last stage, 168-byte main data and a 4-byte error detecting code (EDC) are stored. In each of the intermediate stages from the second stage to the eleventh stage, 172-byte main data is stored.

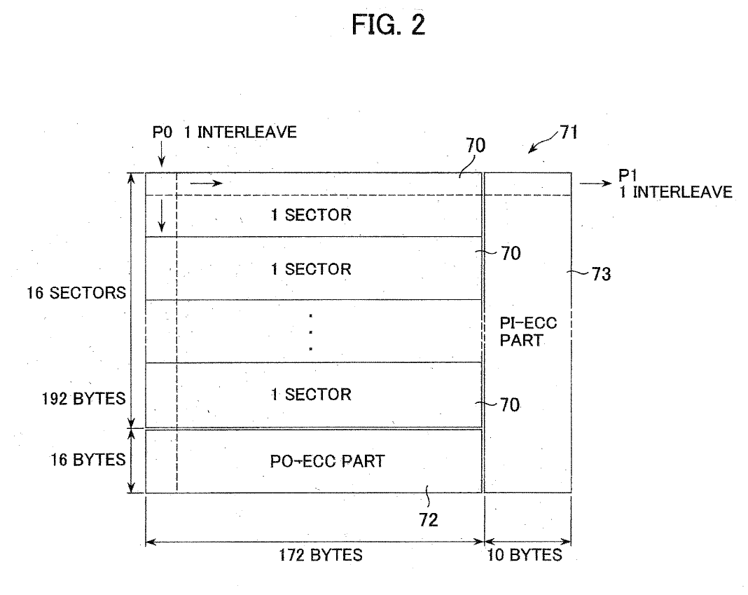

During typical operation, main data inside each sector 70 is scrambled when being recorded on a DVD. As shown in FIG. 2, a PO error correcting code (PO-ECC part) 72 is attached to the 16 sectors in the column direction (e.g., in the vertical direction as shown in FIG. 2) and a PI error correcting code (PI-ECC part) 73 is attached to the 16 sectors in the row direction to form an ECC block 71. In this embodiment, the PO-ECC part 72 includes an error correcting code for data in the PO direction (e.g., in the column direction as shown in FIG. 2) extending over the sectors 70. The PI-ECC part 73 includes an error correcting code for data in the PI direction (e.g., in the row direction as shown in FIG. 2), including the PO-ECC part 72.

The PI-ECC part 73 is attached to the ECC block 71 to generate a syndrome for performing error corrections for every row in the PI direction in the ECC block 71, that is, for every PI interleave. Also, the PO-ECC part 72 is attached to the ECC block 71 to generate a syndrome for performing error corrections for every column in the PO direction inside the ECC block 71, that is, for every PO interleave.

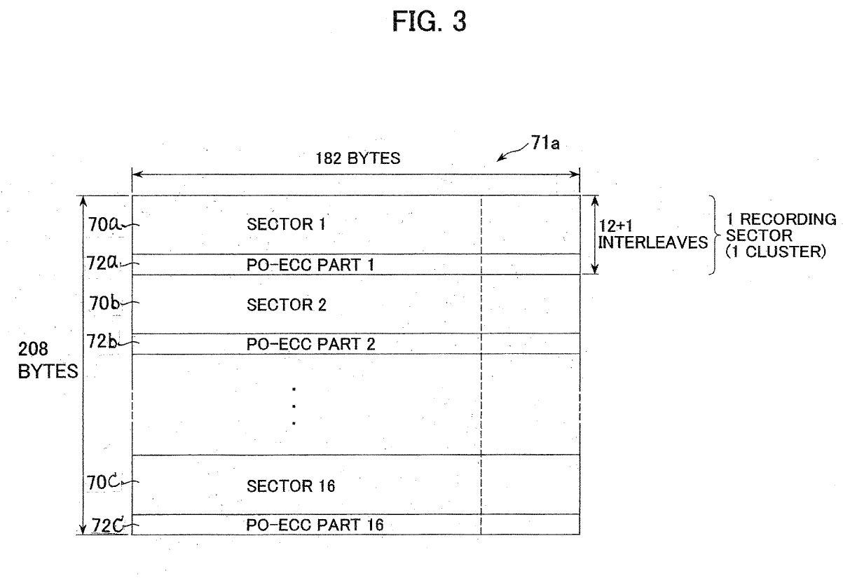

The ECC block 71 is stored on a DVD-ROM which is described in a coding format shown in FIG. 3. As shown in FIG. 3, the PO-ECC part 72 is divided into interleaves 72a, 72b, 72c, and, for example, one interleave 72a is inserted between sector 70a and sector 70b. One recording sector (one cluster) is constituted by one sector (70a, 70b, or 70c) and one interleave of the PO-ECC part (72a, 72b, or 72c).

With the above-described format, high error detection/correction performance is ensured when reproducing data.

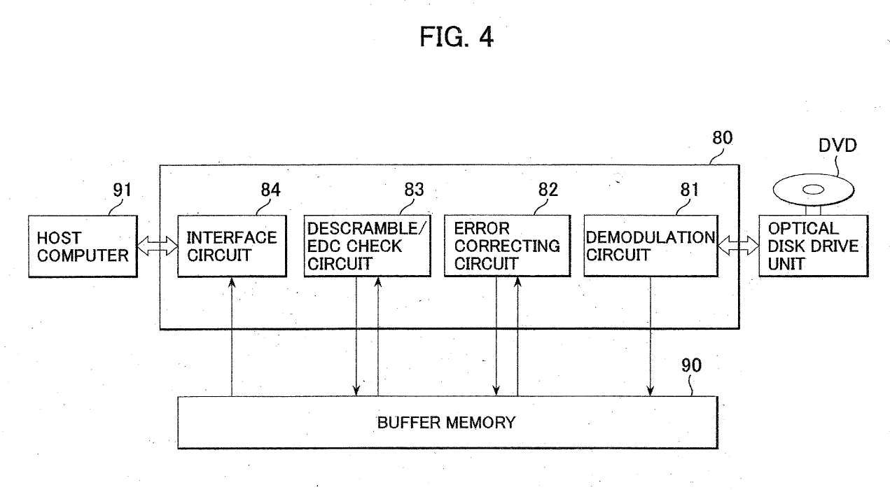

FIG. 4 shows a controller 80 that performs input/output operations of data to/from a recording medium. A demodulation circuit 81 reads data from the DVD-ROM as a recording medium. The demodulated data, including the ECC block 71, is stored in a buffer memory 90. Next, an error correcting circuit 82 reads the ECC block 71 stored in the buffer memory 90 and performs error correction on the ECC block 71.

At first, the error correcting circuit 82 performs error correction in the PI direction. That is, the error correcting circuit 82 reads data in each PI interleave of the ECC block on a byte-by-byte basis, successively performs an operation on the data to generate a PI syndrome, and performs error correction for any error that occurs in the PI interleave, based on the PI syndrome. Then, the error correcting circuit 82 performs error correction in the PO direction. That is, the error correcting circuit 82 reads data in each PO interleave of the ECC block on a byte-by-byte basis, successively performs an operation on the data to generate a PO syndrome, and performs error correction on any error that occurs in the PO interleave, based on the PO syndrome.

Then, the error correcting circuit 82 stores the error-corrected data in the buffer memory 90. Next, a descramble circuit/EDC check circuit 83 reads the error-corrected data from the buffer memory 90. The descramble circuit/EDC check circuit 83 descrambles the error-corrected data, performs an EDC check, and stores the descrambled data in the buffer memory 90. Subsequently, an interface circuit 84 reads the descrambled data from the buffer memory 90 and outputs the data to an external device, such as a host computer 91.

In recent years, with increasing processing speed of host computers 91, faster read/write speed of data from/to storage devices is needed. For example, in a storage device such as an optical disk, the read speed may be increased by controlling the optical disk, which is a storage medium, to rotate twice or more, for example, the standard speed of optical disk used in slower devices.

However, in some cases, the read speed cannot be made faster by increasing access of the buffer memory 90. That is, for access to the buffer memory 90 shown in (1) to (6) below, the read speed cannot be made faster, and therefore, error correction cannot be made faster.

(1) Input of an ECC block before error correction from the demodulation circuit 81;

(2) Reading of an ECC block before correction by the error correcting circuit 82;

(3) Input of error-corrected data from the error correcting circuit 82;

(4) Reading of error-corrected data by the descramble circuit 83;

(5) Input of descrambled data from the descramble circuit 83; and/or

(6) Reading of descrambled data by the interface circuit 84.

Thus, as shown in FIG. 4, a controller to control storage of one ECC block temporarily in an internal buffer memory is provided so that the error correcting memory and the descramble circuit are able to access the internal buffer memory. Since the amount of access to the external buffer memory by the error correcting circuit and descramble circuit is thereby reduced, the overall amount of access to the buffer memory can also be reduced.

However, the error correcting circuit also needs to perform error correction on data in ECC blocks. Therefore, the internal buffer memory in the controller needs to include a large-capacity memory capable of storing all data in an ECC block. As a result, the circuit size of the controller increases. Further, when performing error correction in the PI direction and in the PO direction alternately, the error correction time is lengthened. Thus, the memory capacity of the internal buffer memory may be increased so that a plurality of ECC blocks can be stored. Therefore, the circuit size of the controller may need to be even larger.

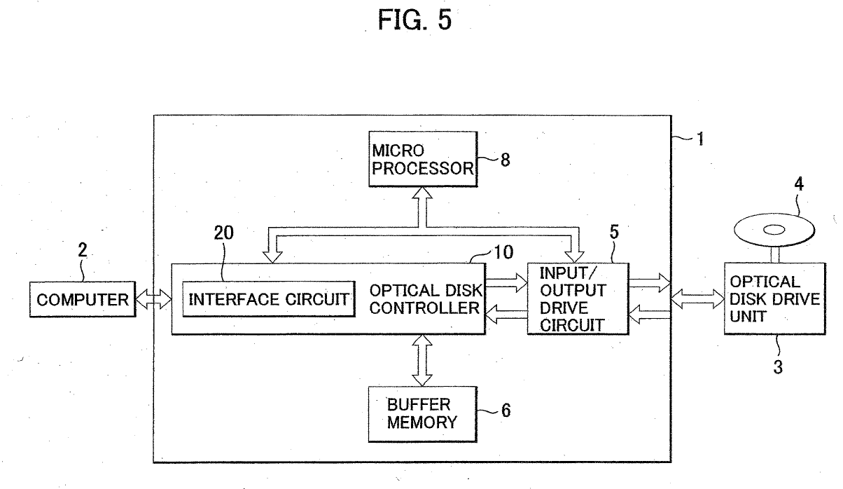

As shown in FIG. 5, an optical disk control device 1 functioning, for example, as a data reader is coupled to a computer 2 via a predetermined interface, such as ATAPI (AT attachment packet interface). The optical disk control device 1 is also coupled to an optical disk driving device 3 via an interface.

The optical disk driving device 3 drives an HD-DVD (High Definition Digital Video Disk) 4, for example, as a recording medium rotating at a predetermined speed. The optical disk driving device 3 reads disk data stored in the HD-DVD 4 using an optical pickup device (not shown). The optical disk driving device 3 outputs the disk data to the optical disk control device 1.

The output disk data is input into an input/output drive circuit 5 of the optical disk control device 1. The input/output drive circuit 5 outputs the disk data to an optical disk controller (controller) 10, which functions as an error correcting device.

The controller 10 performs various processing functions, such as (1) sending instructions to the optical disk driving device 3, (2) receiving status information from the optical disk driving device 3, (3) decoding a read format from the HD-DVD 4, which functions as an optical disk, (4) performing error corrections on the read format, (5) transferring data between the optical disk driving device 3 and an external buffer memory 6, and (6) transferring data between an interface circuit 20 and the external buffer memory 6. That is, the controller 10 descrambles disk data input from the input/output drive circuit 5. The controller 10 also generates various syndromes, such as an EDC syndrome, a PI syndrome, and a PO syndrome. Then, the controller 10 stores descrambled data and various syndromes in the external buffer memory 6. The controller 10 also performs error correction on the descrambled data stored in the external buffer memory 6, based on various syndromes stored in the external buffer memory 6. Then, the controller 10 transfers error-corrected data stored in the external buffer memory 6 to the computer 2 via the interface circuit 20, based on instructions from a microprocessor 8.

The format of data recorded on the HD-DVD 4 will now be described.

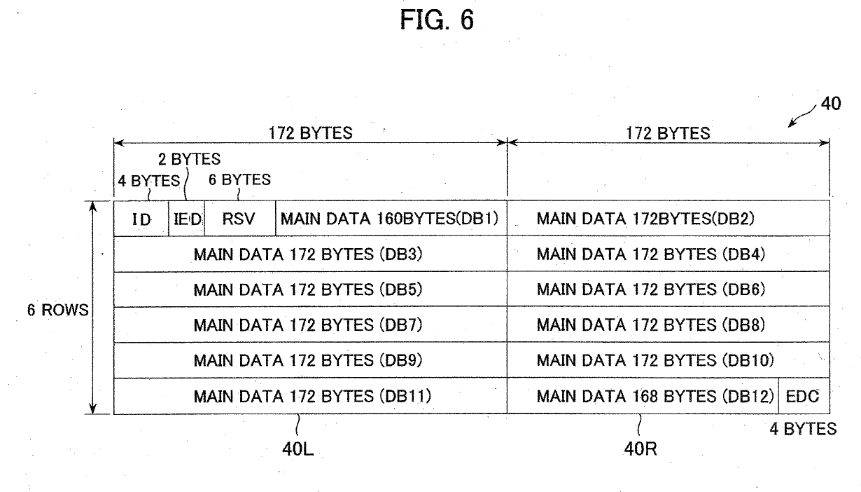

First, the details for one sector 40 will be described. As shown in FIG. 6, an exemplary sector 40 includes 6-rows×2-columns of main data. A4-byte identification data ID, a2-byte ID error detection signal IED, and a 6-byte reserved area RSV are attached to the head of the sector. A 4-byte error detection code EDC is attached to the end of the sector.

Each sector 40 includes 12 data blocks DB1 to DB12. The 12 data blocks DB1 to DB12 are two-dimensionally arranged by a predetermined numbers of rows and columns (6 rows×2 columns in the embodiment shown in FIG. 6). More specifically, for example, odd-numbered data blocks DB1, DB3, DB5, DB7, DB9, and DB11 are arranged in a left frame (the first column, that is, the left column as viewed in FIG. 6) 40L in sequential order. Even-numbered data blocks DB2, DB4, DB6, DB8, DB10, and DB12 are arranged in a right frame (the second column, that is, the right column as viewed in FIG. 6) 40R in sequential order. The first data block DB1 includes, 12 bytes of the identification data ID, ID error detection signal IED, reserved area RSV, and 160 bytes of stored main data. In the second data block DB2 to the eleventh data block DB11, 172 bytes of main data are stored. In the twelfth data block DB12, 168 bytes of main data and 4 bytes of error detection code EDC are stored.

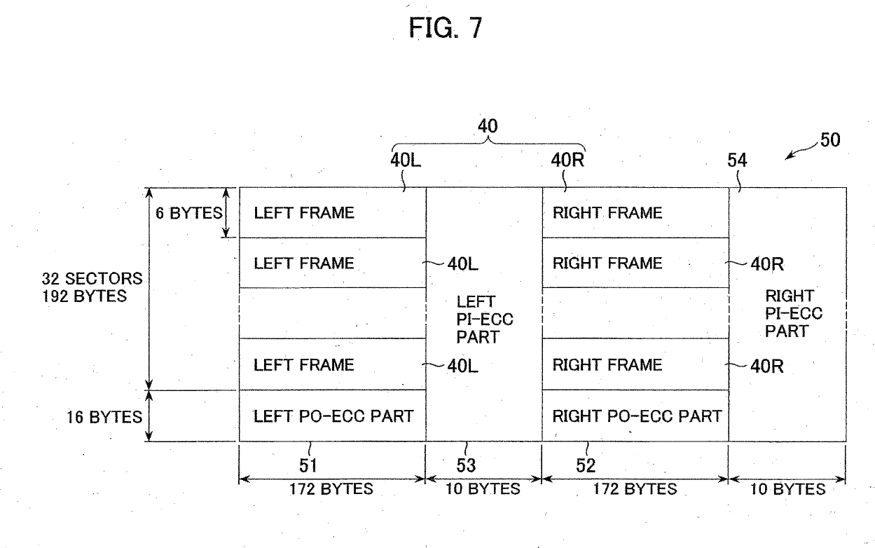

It is noted that optical disks, such as HD-DVD 4 and DVD disks, typically have a very high rate of error occurrence of read data because of, among other things, a huge storage capacity, defects when manufacturing disks, and dirt attached to the surface of disks and the like. As shown in FIG. 7, a left PO-ECC part 51 and a right PO-ECC 52, for example, are attached in the column direction (the vertical direction as shown in FIG. 7) for each sector 40. A left PI-ECC part 53 and a right PI-ECC 54 are also attached to each sector 40 in the row direction (the horizontal direction as shown in FIG. 7). An ECC block 50 to be recorded on the HD-DVD 4, for example, is thereby formed by these additions. Here, the left PO-ECC part 51 contains error correcting code for data in the PO direction (column direction as shown in FIG. 7) extending throughout the left frame 40L of each sector 40. The right PO-ECC part 52, as shown in FIG. 7, contains error correcting code for data in the PO direction extending through out the right frame 40R of each sector 40. Also, the left PI-ECC part 53 contains error correcting code for data in the PI direction (row direction as shown in FIG. 7) in the left frame 40L of each sector 40 and the left PO-ECC part 51. The right PI-ECC part 54 contains error correcting code for data in the PI direction in the right frame 40R of each sector 40 and the right PO-ECC part 52, as shown in FIG. 7.

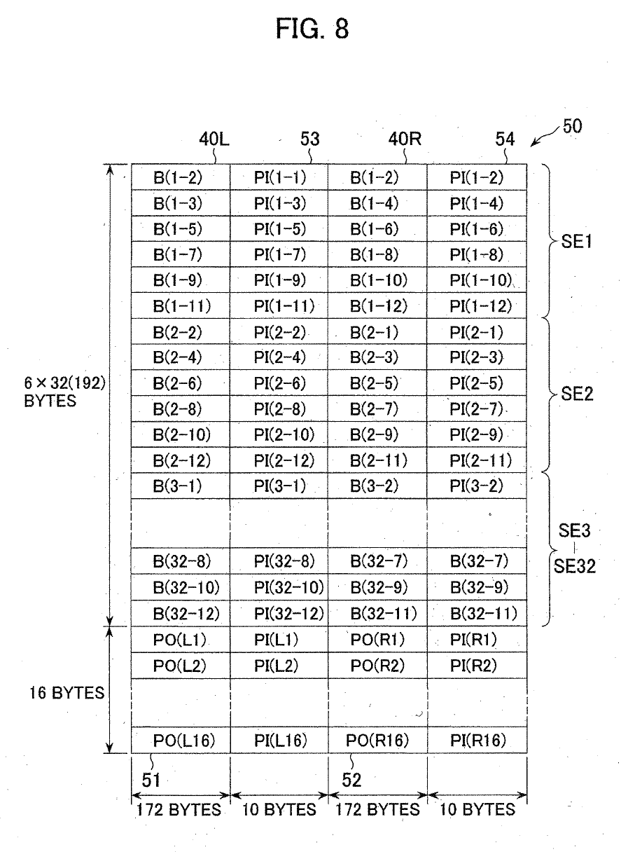

The above ECC block 50 will now be described in detail. In the embodiment shown in FIG. 8, for convenience of description, each sector 40 portion (the left frame 40L and the right frame 40R as shown in FIG. 8) of the ECC block 50 is represented by a block B (sector number—data block number), as shown in FIG. 8. That is, for example, the block B (1-1) denotes data in the first data block DB1 of the first sector SE1. Then, for odd-numbered sectors (for example, the first sector SE1, third sector SE3, and so on) and even-numbered sectors (for example, the second sector SE2, fourth sector SE4, and soon), data blocks DB are arranged symmetrically. That is, for odd-numbered sectors, odd-numbered data blocks (for example, the first data block DB1, third data block DB3, and so on) are arranged in the left frame 40L and even-numbered data blocks (for example, the second data block DB2, fourth data block DB4, and so on) are arranged in the right frame 40R, as shown in FIG. 8. For even-numbered sectors, on the other hand, odd-numbered data blocks are arranged in the right frame 40R and even-numbered data blocks are arranged in the left frame 40L.

The left PO-ECC part 51 and the right PO-ECC part 52, which are computed based on data of each column, are attached to each left frame 40L portion and each right frame 40R portion, respectively, as shown in FIG. 8. Both PO-ECC parts 51 and 52 include a predetermined error correcting code (for example, the Reed-Solomon product code), and a computed error correcting code of the predetermined number of bits (16 bytes in the embodiment, shown in FIG. 8), in accordance with the number of pieces of data of each column, are attached thereto. Each block constituting the left PO-ECC part 51 is denoted by a block PO (stage number Li). That is, the block PO (L1) denotes PO-ECC in the first stage of the left PO-ECC part 51. Each block constituting the right PO-ECC part 52 is denoted by a block PO (stage number Ri). That is, the block PO (R1) denotes PO-ECC in the first stage of the right PO-ECC part 52.

Further, the left PI-ECC part 53, which is computed based on data of each row, is attached to each block of the left frame 40L and the left PO-ECC part 51, as shown in FIG. 8. Also, the right PI-ECC part 54, which is computed based on data of each row, is attached to each block of the right frame 40R and the right PO-ECC part 52, as shown in FIG. 8. Both PI-ECC parts 53 and 54 include a predetermined error correcting code (for example, the Reed-Solomon product code), and a computed error correcting code of the predetermined number of bits (10 bytes in the embodiment, as shown in FIG. 8) in accordance with the number of pieces of data of each row are attached thereto. Each block constituting the left PI-ECC part 53 is denoted by a block PI (corresponding block number). That is, the block PI (1-1) denotes PI-ECC, corresponding to the first data block DB1 of the first sector SE1, as shown in FIG. 8. Also, the block PI (L1) denotes PI-ECC, corresponding to PO-ECC in the first stage of the left PO-ECC part 51, as shown in FIG. 8. In other words, PI-ECC of the block PI (1-1) is computed based on data in the first data block DB1 of the first sector SE1 and is attached. PI-ECC of the block PI (L1) is computed based on PO-ECC in the first stage of the left PO-ECC part 51 and is attached.

Each block PI constituting the right PI-ECC part 54 is denoted by a block PI (corresponding block number). That is, the block PI (1-2) denotes PI-ECC, corresponding to the second data block DB2 of the first sector SE1 as shown in FIG. 8. Also, the block PI (R1) denotes PO-ECC, corresponding to PO-ECC in the first stage of the right PO-ECC part 52, as shown in FIG. 8. In other words, as shown in FIG. 8, PI-ECC of the block PI (1-2) is computed based on data of the second data block DB2 of the first sector SE1 and is attached. PI-ECC of the block PI (R1) is computed based on PO-ECC in the second stage of the right PO-ECC part 52 and is attached.

The left PO-ECC part 51 and the right PO-ECC part 52 are attached to generate syndromes for performing error corrections for every column in the PO direction in the ECC block 50. Also, the left PI-ECC part 53, as shown in FIG. 8, is attached to generate syndromes for performing error corrections for every row in the PI direction in the left frame 40L of each sector and the left PO-ECC part 51. The right PI-ECC part 54 is attached to generate syndromes for performing error corrections for every row in the PI direction in the right frame 40R of each sector 40 and the right PO-ECC part 52.

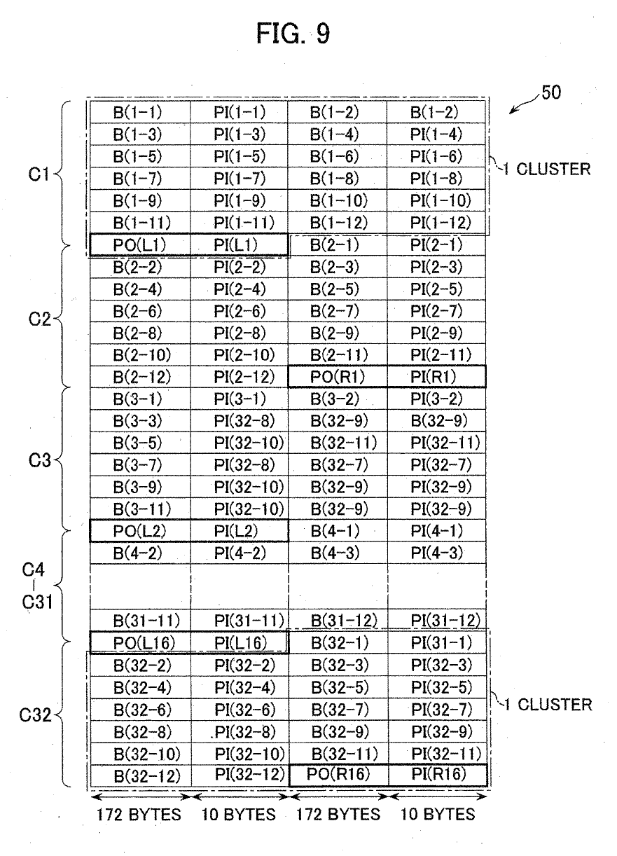

Then, the ECC block 50 is actually stored, in the coding format shown in FIG. 9, on the HD-DVD 4, as shown in FIG. 5. That is, in the ECC block 50, each sector portion and each of the PO-ECC parts 51 and 52, as shown in FIG. 8, are divided into a predetermined number of parts, and the order of data is interchanged (interleaved). As shown in FIG. 9, for example, each sector portion is divided into six stages, corresponding to one sector, and each of the PO-ECC parts (51 and 52 as shown in FIG. 8) is contained within one stage. Next, one stage of the left PO-ECC part 51 is inserted into each portion corresponding to odd-numbered sectors, and one stage of the right PO-ECC part 52, as shown in FIG. 8, is inserted into each portion corresponding to even-numbered sectors. Then, as shown by alternate long and short dashed lines in FIG. 9, one recording sector (one cluster) comprises one divided sector portion (data of six stages) and data contained in one inserted stage of the left PO-ECC part (51, as shown in FIG. 8), or the right PO-ECC part (52, as shown in FIG. 8). That is, one ECC block 50 includes 32 clusters C1 to C32. A PI block is attached to each stage of each sector and to each of the PO-ECC parts (51 and 52 as shown in FIG. 8). Addition of odd-numbered clusters (for example, the first cluster C1) and even-numbered clusters (for example, the second cluster C2) produces a block containing a 13-stage×2-column two-dimensional array. Thus, each block array (e.g., C1, C2) in one ECC block includes two clusters.

With the format described above, high error detection/correction performance is ensured in error correction processing when reproducing data.

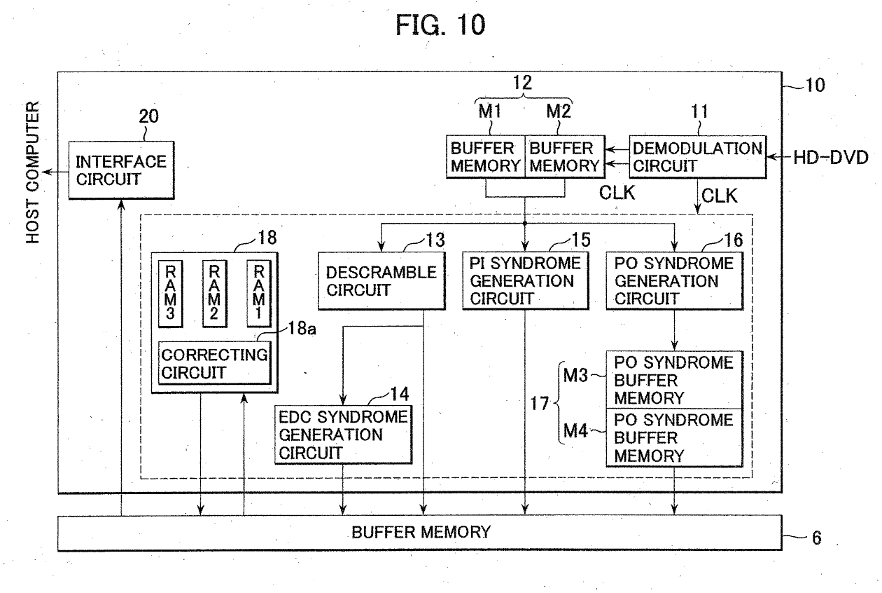

As shown FIG. 10, disk data read from the HD-DVD 4 (FIG. 5) is successively input into the demodulation circuit 11 of the optical disk controller 10 via the input/output drive circuit 5 (FIG. 5). The demodulation circuit 11 converts the input disk data into digital data, and, at the same time, generates a clock signal CLK, synchronized with the digital data. The demodulation circuit 11 further demodulates the digital data and outputs the demodulated data, (e.g., data of the ECC block 50 shown in FIG. 9) in the PI direction and also outputs the clock signal CLK.

An internal memory part 12, into which data of the ECC block 50 (FIG. 9) is input from the demodulation circuit 11, comprises two buffer memories M1 and M2. Each of the buffer memories M1 and M2 has a memory capacity capable of storing data of a predetermined number (e.g., two in the embodiment shown in FIG. 9) of clusters. Here, the memory capacity allowing storage of data of two clusters is set because, as described above, the block array (e.g., C1, c2) in one ECC block includes two clusters. Storing in each array in this way makes it easier to generate PO syndromes, as described further below.

The internal memory part 12 uses one of the buffer memories M1 and M2, at an identical time for data storage, for example, for storing data from the demodulation circuit 11. The internal memory part 12 then uses the other buffer memory for access by a descramble circuit 13. That is, when the buffer memory M1 is used for data storage, the buffer memory M2 is used for access, and when the buffer memory M2 is used for data storage, the buffer memory M1 is used for access.

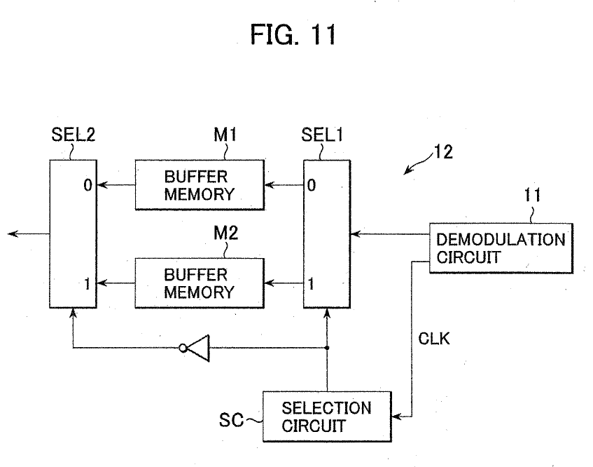

FIG. 11 shows a circuit configuration example of the internal memory part 12. As shown in FIG. 11, data input from the demodulation circuit 11 is input into a first selector SEL1. A selection signal from a selection circuit SC is also input into the first selector SELL. The selection circuit SC counts the clock signal CLK input from the demodulation circuit 11 and switches the signal level of a selection signal based on a predetermined timing. In the embodiment shown in FIG. 11, the selection circuit SC switches the signal level of the selection signal each time the clock for two clusters is counted. The selection signal is also input into a second selector SEL2 via an inverter.

The first selector SEL1 outputs, based on the signal level of the selection signal from the selection circuit SC, data from the demodulation circuit 11 to the buffer memory M1 or the buffer memory M2. The second selector SEL2, based on the signal level of the selection signal received from the selection circuit SC input via the inverter, makes the output of one of the buffer memory M1 and the buffer memory M2 accessible.

As further shown in FIG. 10, the descramble circuit 13 reads data of the ECC block 50 (FIG. 9) in the PI direction from the internal memory part 12. The descramble circuit 13 descrambles main data read from the ECC block 50. The descramble circuit 13 outputs the descrambled data to the external buffer memory 6 and to an EDC syndrome generation circuit 14.

The EDC syndrome generation circuit 14 generates an EDC syndrome, by performing an EDC calculation on the descrambled data input from the descramble circuit 13, and stores the EDC syndrome in the external buffer memory 6. In the embodiment shown in FIG. 10, since data input into the EDC syndrome generation circuit 14 is uncorrected data, the EDC syndrome generation circuit 14 generates a syndrome by extracting only error components of the error detecting code EDC.

A PI syndrome generation circuit 15 reads data from the ECC block 50 (FIG. 9) in the PI direction from the internal memory part 12. The PI syndrome generation circuit 15 generates a PI syndrome, including error components in each row, based on the data read in the PI direction, and stores the PI syndrome in the external buffer memory 6.

A PO syndrome generation circuit 16 reads the ECC block 50 of FIG. 9 in the PO direction from the internal memory part 12. The PO syndrome generation circuit 16 generates, based on the data read in the PO direction, an intermediate value of a PO syndrome of each row for the predetermined number of bytes (in the embodiment of FIG. 9, for two clusters, that is, 13 bytes) and stores the intermediate value of the PO syndrome in a PO syndrome memory part 17. The PO syndrome generation circuit 16 also reads the intermediate value of the PO syndrome, then updates the intermediate value of the PO syndrome based on the intermediate value of the PO syndrome and data from the ECC block 50 (FIG. 9) in the PO direction, and stores the PO syndrome in the PO syndrome memory part 17.

As shown in FIG. 9, the HD-DVD format includes the feature that each block array (e.g., C1, c2) is two clusters. By storing data for two recording sectors in each memory portion included in the internal memory part 12, an intermediate result for the PO syndrome can be generated for each pair of recording sectors in the array.

As shown in FIG. 10, the PO syndrome memory part 17 comprises two PO syndrome buffer memories M3 and M4. Each of the buffer memories M3 and M4 has a storage capacity capable of storing PO syndromes for all columns in one ECC block, that is, for example, a storage capacity capable of storing 5,824 (364×16) bytes. The PO syndrome memory part 17 stores the final PO syndrome for each column, which includes an intermediate value of the PO syndrome stored after reading data of an entire ECC block, in the external buffer memory 6. The PO syndrome memory part 17 uses one of the buffer memory M3 and buffer memory M4, at an identical time for syndrome storage, for example, for storing an intermediate value of the PO syndrome received from the PO syndrome generation circuit 16. The PO syndrome memory part 17 then uses the other buffer memory (buffer memory M4 or buffer memory M3) for syndrome output, outputting the final PO syndrome to the external buffer memory 6. That is, when the buffer memory M3 is used for syndrome storage, the buffer memory M4 is used for syndrome output, and when the buffer memory M4 is used for syndrome storage, the buffer memory M3 is used for syndrome output. In the embodiment of FIG. 10, the PO syndrome memory part 17 has approximately the same configuration as that of the internal memory part 12.

An error correcting circuit 18 reads a PI syndrome from the external buffer memory 6 and stores the PI syndrome in a memory RAM1 for PI. The error correcting circuit 18 reads a PO syndrome from the external buffer memory 6 and stores the PO syndrome in a memory RAM2 for PO. The error correcting circuit 18 reads an EDC syndrome from the external buffer memory 6 and stores the EDC syndrome in a memory RAM3 for EDC. A correcting circuit 18a performs error correction on any descrambled main data stored in the external buffer memory 6 based on the various syndromes.

As shown in FIG. 10, based on instructions from the microprocessor 8 (FIG. 5), the interface circuit 20 reads error-corrected data stored in the external buffer memory 6 and outputs the data to the computer 2 (FIG. 5).

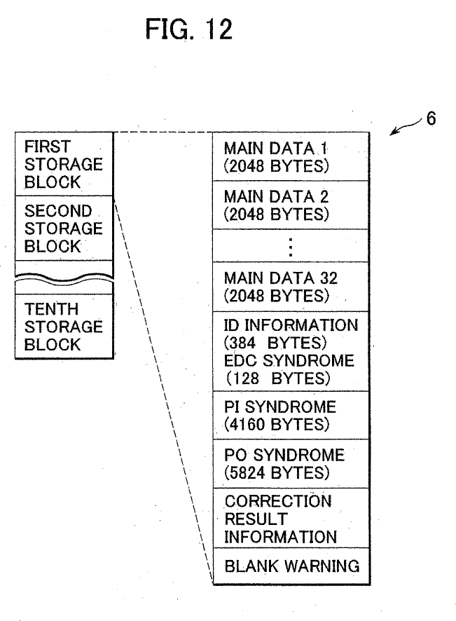

As shown in FIG. 12, the external buffer memory 6 comprises a plurality (10 in the embodiment of FIG. 12) of storage blocks. In each storage block, descrambled main data from one ECC block 50 (FIG. 9), ID information, EDC syndromes, PI syndromes, and PO syndromes are stored. Thus, in the embodiment of FIG. 12, the external buffer memory 6 can store main data and various syndromes for up to 10 ECC blocks 50 (FIG. 9).

Next, operations of the optical disk controller 10 configured as described above will be described.

As shown in FIG. 10, the demodulation circuit 11 reads disk data in the PI direction from the HD-DVD before demodulating the disk data. Then, the demodulation circuit 11 stores the demodulated data (the ECC block 50, as shown in FIG. 9) in one of the first and second buffer memories M1 and M2 of the portion of the internal memory 12 selected for data storage. Data from two clusters of the ECC block 50 (FIG. 9) are stored in one buffer memory.

The descramble circuit 13 and the PI syndrome generation circuit 15 read the ECC block 50 (FIG. 9) in the PI direction (as shown in FIG. 9) from one of the first and second buffer memories M1 and M2 selected for access. The descramble circuit 13 descrambles data from the read ECC block 50 (FIG. 9) and stores the descrambled data in the external buffer memory 6. The descramble circuit 13 also outputs descrambled data to the EDC syndrome generation circuit 14. The EDC syndrome generation circuit 14 generates, based on the input descrambled data, a 4-byte EDC syndrome for each cluster, and successively stores the EDC syndrome for each cluster in the external buffer memory 6.

The PI syndrome generation circuit 15 generates a 10-byte PI syndrome for each data block (such as block B (1-1)) and each PI block (such as block PI (1-1)) in the ECC block 50 (as shown in FIG. 9) read from the internal memory part 12, and successively stores the PI syndrome in the external buffer memory 6. More specifically, in the example shown in FIG. 9, first the PI syndrome generation circuit 15 reads data in block B (1-1) in the PI direction and then data in block PI (1-1) in the PI direction. The PI syndrome generation circuit 15 (FIG. 10) generates one PI syndrome using data from blocks B (1-1) and PI (1-1). Next, the PI syndrome generation circuit 15 (FIG. 10) reads data in block B (1-2), in the PI direction, and then data in block PI (1-2), in the PI direction, as shown in FIG. 9. The PI syndrome generation circuit 15 generates one PI syndrome using data from blocks B (1-2) and PI (1-2). As a result, two PI syndromes are generated from the data in each row of the ECC block 50. Further, the PI syndrome generation circuit 15 (FIG. 10) reads data in block B (1-3) in the PI direction and then data in block PI (1-3) in the PI direction, as shown in FIG. 9. Subsequent data is also read by the PI syndrome generation circuit 15 (FIG. 10), in the same order, to generate PI syndromes. Then, each time the PI syndrome is generated, the PI syndrome generation circuit 15 stores the PI syndrome in the external buffer memory 6.

Contemporaneously with generation of a PI syndrome, for example, the PO syndrome generation circuit 16 (FIG. 10) reads the ECC block 50 in the PO direction, as shown in FIG. 9, from one of the first and second buffer memories M1 and M2 selected for access. Since, at this point, data from only two arbitrary clusters in the ECC block 50 are stored in the buffer memory, the PO syndrome generation circuit 16 (FIG. 10) generates a PO syndrome for every two clusters in the column direction, that is, every 13 bytes of data.

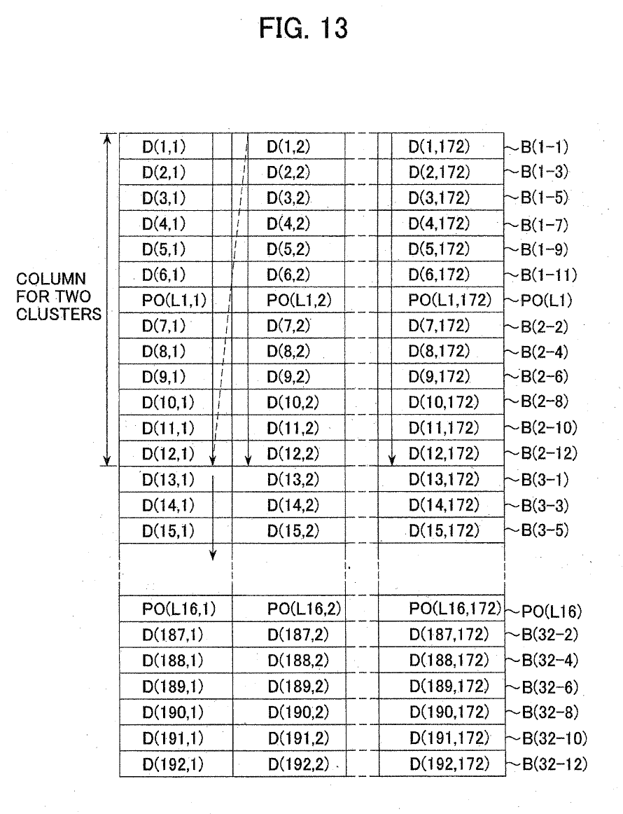

For the embodiment shown in FIGS. 9 and 10, the read order by the PO syndrome generation circuit 16 is shown in FIG. 13. FIG. 13 shows the data array of each block from the block B (1-1) to the block B (32-12) arranged in the PO direction, as shown in FIG. 9. Each block comprises 172-byte data D. Block B (1-1) includes data D (1, 1) to data D (1, 172). Each column comprises 208-byte data D. The first column includes data D (1, 1) to data D (192, 1) and data PO (L1, 1) to data PO (L1, 16).

The PO syndrome generation circuit 16 (FIG. 10) reads, as shown by the solid line arrows in FIG. 13, 13-byte data in the order of data D (1, 1) to data D (6, 1), data PO (L1, 1), and data D (7, 1) to data D (12, 1). The PO syndrome generation circuit 16 (FIG. 10) generates one PO syndrome from the above read 13-byte data. Then, the PO syndrome generation circuit 16 (FIG. 10) stores the PO syndrome as an intermediate value of the PO syndrome in the buffer memory of the PO syndrome memory portion 17 (FIG. 10) selected for syndrome storage. Next, the PO syndrome generation circuit 16 (FIG. 10) reads the 13-byte data in the order of data D (1, 2) to data D (6, 2), data PO (L1, 2), and data D (7, 2) to data D (12, 2). Then, the PO syndrome generation circuit 16 (FIG. 10) generates an intermediate value of one PO syndrome from the above read 13-byte data. As described above, the PO syndrome generation circuit 16 (FIG. 10) reads, for each column, data from two clusters stored in the internal memory part 12 (FIG. 10) and also generates an intermediate value of the PO syndrome. When reading from the last column (the 364th column in the embodiment of FIG. 9) in the ECC block 50 (FIG. 9) is completed, the PO syndrome generation circuit 16 (FIG. 10) successively reads data from the first column data of the next two clusters, that is, from data D (13, 1), as shown in FIG. 13. At this point, the PO syndrome generation circuit 16 (FIG. 10) reads the intermediate value of the PO syndrome, which was previously generated, from the buffer memory of the PO syndrome memory portion 17 (FIG. 10) selected for syndrome storage, and generates a PO syndrome from the read 13-byte data and the intermediate value of the PO syndrome. Then, the PO syndrome generation circuit 16 (FIG. 10) stores the generated PO syndrome as an intermediate value for a new PO syndrome in the buffer memory selected for syndrome storage.

When reading of all data in one ECC block is completed, selection for syndrome storage or syndrome output is switched between the buffer memories M3 and M4 in the PO syndrome memory part 17 (FIG. 10). Accordingly, the final PO syndrome for each column in one ECC block is stored in the buffer memory that is switched to syndrome output from syndrome storage. The buffer memory switched to syndrome output stores the final PO syndrome for each column in the external buffer memory 6 (FIG. 10).

As described above, storage of intermediate results for PO syndromes from the PO syndrome generation circuit and output of the PO syndromes to the external memory can be performed simultaneously. Therefore, since storage of intermediate results of PO syndromes is not limited as a result of the need to output the PO syndromes to the external memory, intermediate results of PO syndromes can continuously be stored.

When descrambled main data of one ECC block, PI syndromes, PO syndromes, and EDC syndromes are stored in the external buffer memory 6 (FIG. 10), the error correcting circuit 18 (FIG. 10) reads only selected syndromes of PI syndromes, PO syndromes, and EDC syndromes from the external buffer memory 6 (FIG. 10). The error correcting circuit 18 (FIG. 10) stores the PI syndromes, PO syndromes, and EDC syndromes in a memory RAM1 for PI, a memory RAM2 for PO, and a memory RAM3 for EDC, respectively, for example.

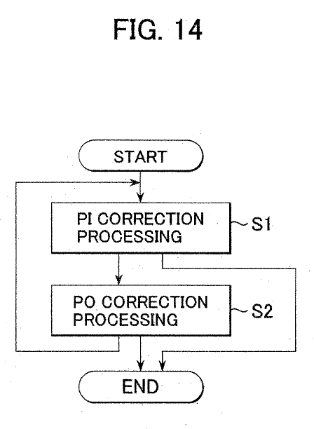

Next, in accordance with the respective process diagrams shown in FIGS. 14 to 16, the error correcting circuit 18 (FIG. 10) performs error corrections on the main data stored in the external buffer memory 6 (FIG. 10) and the selected syndromes stored in the memories RAM1, RAM2, and RAM3 (FIG. 10).

In step S1 shown in FIG. 14, the correcting circuit performs PI error correction in the PI direction. At this point, the correcting circuit performs an EDC check on the PI error correction. If any error remains, based on the result of the EDC check, the correcting circuit proceeds to step S2. Then, when no error remains, the correcting circuit terminates the error correction. In step S2, the correcting circuit performs PO error correction in the PO direction. At this point, the correcting circuit performs an EDC check on the PO error correction. If any error remains based on the result of the EDC check, the correcting circuit proceeds to step S1. Then, the correcting circuit repeats step S1 and step S2 until no error remains. Then, when no error remains, the correcting circuit terminates the error correction.

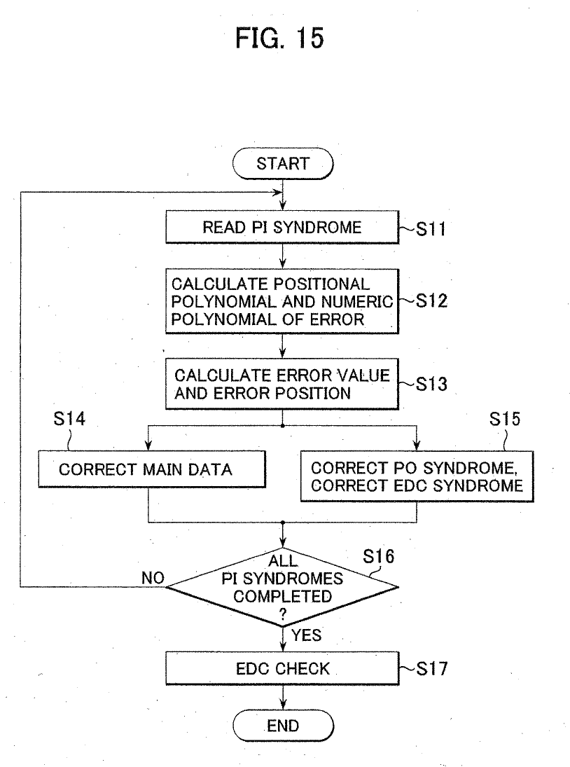

Step S11 to step S17 shown in FIG. 15 are sub-steps of the PI error correction (step S1) shown in FIG. 14. That is, in step S11, the correcting circuit reads one PI syndrome from the memory RAM1 for PI. In step S12, the correcting circuit calculates a positional polynomial and a numeric polynomial of the error, based on the read PI syndrome. For the computation, for example, the Euclidian mutual division algorithm may be used. Next, in step S13, the correcting circuit calculates, based on the error positional polynomial and error numeric polynomial, an error position and an error value. For the computation, for example, Chien's algorithm (Chien search) may be used.

Subsequently, in step S14, the correcting circuit corrects, based on the calculated error position and error value, errors of main data stored in the external buffer memory, that is, main data of the block corresponding to the PI syndrome read in step S12. More specifically, the correcting circuit performs error corrections in this example by reading data corresponding to the error position from the external buffer memory and writing an exclusively ORed result of the data and the error value to the external buffer memory.

Approximately contemporaneously with step S14, the correcting circuit corrects, in step S15, any PO syndromes and EDC syndromes to be corrected. That is, the correcting circuit calculates, based on the calculated error position and error value, a PO syndrome correction value. Then, the correcting circuit reads the corresponding PO syndrome from the memory RAM2 for PO. The correcting circuit performs PO syndrome corrections by writing an exclusively ORed result of the PO syndrome and the PO syndrome correction value to the memory RAM2 for PO. Also, the correcting circuit calculates, based on the calculated error position and error value, an EDC syndrome correction value. Then, the correcting circuit reads the corresponding EDC syndrome from the memory RAM3 for EDC. The correcting circuit performs EDC syndrome corrections by writing an exclusively ORed result of the EDC syndrome and the EDC syndrome correction value to the memory RAM3 for EDC. If, at this point, corrections are successfully completed, the correcting circuit sets the PI syndrome to “0”.

Next, the correcting circuit determines, in step S16, whether the reading of all PI syndromes in one ECC block has been completed. The correcting circuit repeats the above steps S11 to S15 until reading of all PI syndromes is completed. Then, when reading of all PI syndromes is completed, the correcting circuit proceeds to step S17.

The correcting circuit reads, in step S17, EDC syndromes from the memory RAM3 for EDC, and performs an EDC check. That is, the correcting circuit determines that error corrections are successfully completed when all EDC syndromes are “0”. If there is a “1” for any EDC syndrome, it is determined that the error corrections are not completed, and PO error corrections are made by returning to step S2 in FIG. 14.

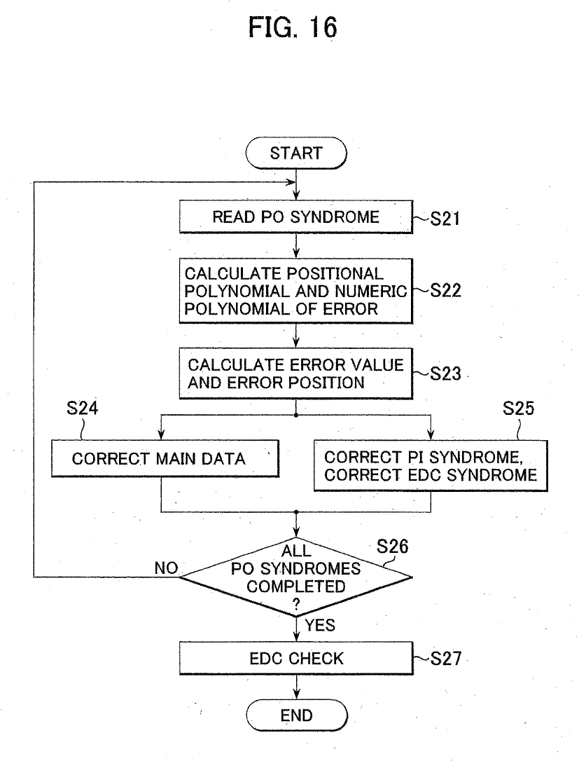

Step S21 to step S27 shown in FIG. 16 are sub-steps of the PO error correction (step S2) shown in FIG. 14. In step S21, the correcting circuit reads one PO syndrome from the memory RAM12 for PO. In step S22, the correcting circuit calculates a positional polynomial and a numeric polynomial for an error based on the read PO syndrome. For example, the Euclidian mutual division algorithm may be used for the computation. Next, in step S23, the correcting circuit calculates an error position and an error value, based on the error positional polynomial and error numeric polynomial. For example, Chien's algorithm (Chien search) may be used for the computation.

Subsequently, in step S24, the correcting circuit corrects, based on the calculated error position and error value, errors in the main data stored in the external buffer memory, that is, main data of the column corresponding to the PO syndrome read in step S22. More specifically, for example, the correcting circuit may perform error corrections by reading data corresponding to the error position from the external buffer memory and writing an exclusively ORed result of the data and the error value to the external buffer memory.

Approximately contemporaneously with step S24, the correcting circuit corrects, in step S25, any PI syndromes and EDC syndromes needing correction. That is, the correcting circuit calculates, based on the calculated error position and error value, a PI syndrome correction value. Then, the correcting circuit reads the corresponding PI syndrome from the memory RAM1 for PI. The correcting circuit performs PI syndrome corrections by writing an exclusively ORed result of the PI syndrome and the PI syndrome correction value to the memory RAM1 for PI. Also, similarly to PI error correction, the correcting circuit performs EDC syndrome corrections. If, at this point, corrections are successfully completed, the correcting circuit sets the PO syndrome to “0”.

Next, the correcting circuit determines, in step S26, whether reading of all PO syndromes in one ECC block has been completed. The correcting circuit repeats the above steps S21 to S25 until reading of all PO syndromes is completed. Then, when reading of all PO syndromes is completed, the correcting circuit proceeds to step S27.

The correcting circuit reads, in step S27, EDC syndromes from the memory RAM3 for EDC, and performs an EDC check. Then, if it is determined that error corrections have successfully been completed, the correcting circuit terminates the error correction. If it is determined that all error corrections are not completed, the correcting circuit repeats the PI corrections (step S1 in FIG. 14).

As shown in FIG. 5, if error corrections are successfully completed in the above error correction, the controller 10 transfers, based on instructions received from the microprocessor 8, error-corrected data stored in the external buffer memory 6 to the computer 2 via the interface circuit 20.

According to the first embodiment described above, for example, the following advantages may be obtained:

(1) After descrambled main data, PI syndromes, PO syndromes, and EDC syndromes are generated based on the ECC block 50 (FIG. 9) read from the demodulation circuit 11, these data are stored in the external buffer memory 6, as shown in FIG. 10. The error correcting circuit 18 reads only the syndromes contained in the external buffer memory 6. Accordingly, the amount of data that the error correcting circuit 18 must read may thereby be reduced, as well as the amount of access to the external buffer memory 6 by the descramble circuit 13 that is needed.

The controller 80 (FIG. 4) controls the following six types of access to external buffer memory:

(a) Input of an ECC block received from a demodulation circuit prior to error correction;

(b) Reading of an ECC block prior to correction by the error correcting circuit;

(c) Input of error-corrected data received from the error correcting circuit;

(d) Reading of error-corrected data by the descramble/EDC check circuit;

(e) Input of descrambled data from the descramble/EDC check circuit; and

(f) Reading of descrambled data by the interface circuit.

As a result, each access involves a large amount of data (a total of about 454,272 bytes, i.e., six actions each involving approximately one ECC block (75,712 bytes)).

As shown in FIG. 10, the controller 10 in the present embodiment controls the following six types of access to the external buffer memory 6.

(A) Input of descrambled data (75,712 bytes);

(B) Input of PI syndromes (4,160 (=416×10) bytes);

(C) Input of PO syndromes (5,824 (=364×16) bytes);

(D) Reading of PI syndromes;

(E) Reading of PO syndromes; and

(F) Reading of error-corrected data.

Since the amount of data in each access is small, even though there are many types of access, the overall amount of access to the external buffer memory 6 can significantly be reduced when compared with access required when using the controller 80 of FIG. 4. Bands in use for the external buffer memory 6 can thereby be reduced, and, thus, it becomes easier to increase transfer speed. As a result, data transfer at a desired speed can be realized, even if cheap and large-capacity/low-speed memories are used in the external buffer memory 6. EDC syndromes are not considered in the above description because the amount of data in EDC syndromes is negligibly small, having only 128 (=4×32) bytes per ECC block, for example.

One-time access is made, as described above, to data of a size corresponding to the amount of data in one ECC block. Then, by accessing various syndromes having data amounts much smaller than that of one ECC block, error corrections for disk data read from an optical disk may be made. Therefore, the amount of access to an external memory (memory) can be significantly reduced.

(2) Descrambled main data, PI syndromes, PO syndromes, and EDC syndromes are stored in the large-capacity external buffer memory 6, as shown in FIG. 10. As a result, there is no need to provide an internal large-capacity memory. Consequently, it is possible to avoid the necessity of increasing the circuit size accompanying increased memory capacity for the internal memory. As a result, the amount of access to the external buffer memory 6 can be reduced, while increase in circuit size is avoided.

In the above configuration, the PO syndrome generation circuits need to store and read an intermediate result from each PO syndrome for every predetermined number of recording sectors, that is, for every two or more bytes. As a result, the amount of access to the PO syndrome memory portion can be reduced, as compared with storing and reading an intermediate result for each PO syndrome for every byte.

(3) As shown in FIG. 10, each syndrome generated by the EDC syndrome generation circuit 14, the PI syndrome generation circuit 15, and the PO syndrome generation circuit 16 is stored in the external buffer memory 6. The error correcting circuit 18 performs error correction by reading each of the stored syndromes. That is, the error correcting circuit 18 is separated from syndrome generation. Main data for a plurality of ECC blocks and each syndrome can be stored in the external buffer memory 6. Accordingly, syndrome generation may be performed without being affected by error correction, even if read data contains many errors and a longer period of time is needed to perform the error correction. Thus, syndromes can be generated continuously and stored in the external buffer memory 6. This approach makes it possible to reduce the influence of error correction time on mechanical operations (e.g., forcing a read operation to temporarily stop by stopping a rotating operation of the HD-DVD 4 while reading disk data).

In contrast, for example, if the error correcting circuit and syndrome generation processing are not separated, each syndrome of the next ECC block will not be able to be stored/generated until error correction processing is complete, and thus, data of the next ECC block will not be able to be read. As a result, in that event, it would be necessary to perform an action to enable continued processing, such as stopping the rotating operation of the HD-DVD 4 while reading disk data. Another option that could be considered is to provide sufficient memory to enable storage of syndromes for a plurality of ECC blocks in the error correcting circuit; however, with this option, the memory capacity of the above memory would necessarily become large, and the problem of a need for increase in circuit size commensurate with the increasing memory capacity would result.

(4) An internal memory portion 12 is provided to store data that is output from the demodulation circuit 11, as shown in FIG. 10. Accordingly, it becomes possible for the descramble circuit 13 and the PI syndrome generation circuit 15 to read data in the PI direction from the internal memory portion 12, and for the PO syndrome generation circuit 16 to read data in the PO direction from the internal memory portion 12. PI syndromes are generated by the PI syndrome generation circuit based on data read in the PI direction, and PO syndromes are generated by the PO syndrome generation circuit based on data read in the PO direction. Therefore, the operations of descramble processing, EDC syndrome generation, PI syndrome generation, and PO syndrome generation can be performed in parallel. This capability enables the overall time of the error correction to be shortened. The memory capacity of the internal memory portion 12 has the capacity to store data for four clusters (9,464 bytes), which is a relatively small capacity when compared with that of a conventional internal memory (75,712 bytes, assuming data for one ECC block). Consequently, the need for increased circuit size is alleviated. Here, the total of amount of data that needs to be stored in the PO syndrome memory portion and the internal memory portion is less than the amount of data contained in one ECC block.

(5) The PO syndrome memory portion 17 is of sufficient size to store an intermediate result (intermediate value) of a PO syndrome received from the PO syndrome generation circuit 16, as shown in FIG. 10. If, for example, data is input in the PI direction from a demodulation circuit, an intermediate result of a PO syndrome can be stored for each byte in the PO syndrome memory portion. Further, since a PO syndrome can be generated while reading an intermediate value of the PO syndrome for each column, a PO syndrome generation circuit common to each column can be used. This approach eliminates the need for providing a PO syndrome generation circuit for all columns. Accordingly, a common circuit can be used for PO syndrome generation of each column, and there is no need to provide a PO syndrome generation circuit for each column. Avoiding the need for an increase in circuit size is thus realized.

Since an intermediate value of a PO syndrome is generated for every two clusters that can be stored in the internal memory portion 12, a PO syndrome only performs a reading and storage operation for every 13 bytes. Bands needed for use by the PO syndrome memory part 17 in the PI direction can thereby be reduced. As a result, PO syndromes can be generated without increasing the circuit size, while the capacity of the internal memory part 12 remains small, and the bands in use by the PO syndrome memory portion 17 are minimized. Further, the PO syndrome memory portion 17 has a capacity capable of storing a syndrome (11,648 bytes) for each column, with the capacity being small compared with the capacity (75,712 bytes, assuming data of one ECC block) of a conventional internal memory, which also allows circuit size to be reduced.

In one embodiment, the capacity is of a size capable of storing data smaller than the size of one ECC block. By reducing the memory capacity to such a capacity, circuit size can be reduced.

(6) As shown in FIG. 10, the internal memory portion 12 comprises two buffer memories M1 and M2, one of which is used for data storage and the other for access. As a result, the functions of storage of data from the demodulation circuit 11 and reading of data from the internal memory portion 12 can be performed at the same time, and disk data from the HD-DVD 4 can continuously be read.

(7) The PO syndrome memory portion 17, as shown in FIG. 10, comprises two buffer memories M3 and M4, one of which is used for PO syndrome storage and the other for PO syndrome output. Storage of an intermediate value of a PO syndrome, and output of the final PO syndrome to the external buffer memory 6, can thereby be performed at the same time. As a result, an intermediate value of a PO syndrome from the PO syndrome generation circuit 16 can continuously be stored.

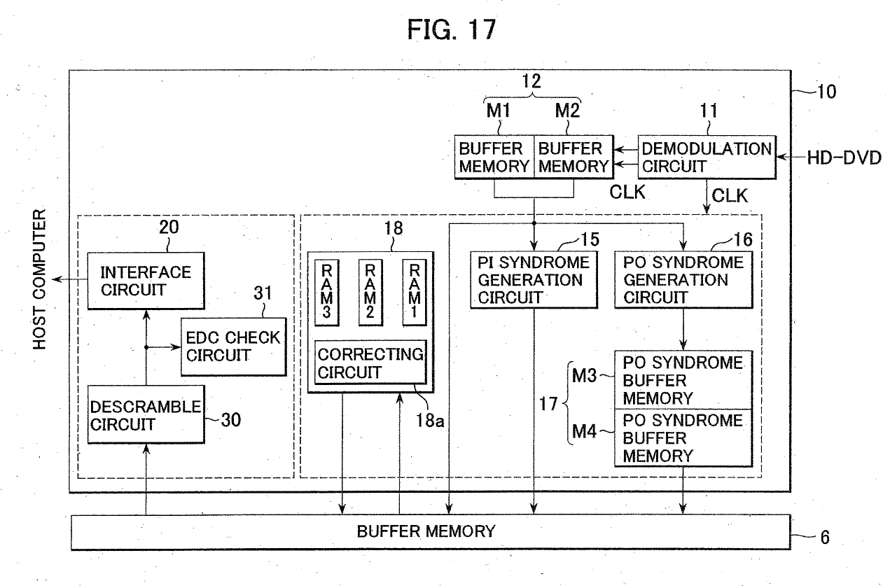

In the first embodiment, error correction is performed on descrambled data, which is obtained by descrambling demodulated data (the ECC block 50 of FIGS. 7-9) in the descramble circuit 13. The approach of this embodiment is not limited to this method, as for example, as shown in FIG. 17, descramble processing may be performed on error-corrected data in a descramble circuit 30. As shown in FIG. 17, demodulated data (the ECC block 50 of FIGS. 7-9) is output from the demodulation circuit 11 to the external buffer memory 6 via the buffer memories M1 and M2. Error correction is performed on the demodulated data stored in the external buffer memory 6 by the correcting circuit 18a. The descramble circuit 30 reads error-corrected data from the external buffer memory 6, descrambles the error-corrected data, and outputs the descrambled data to an EDC check circuit 31. The EDC check circuit 31 performs an EDC check based on the descrambled data received from the descramble circuit 30 and, if no error remains, outputs the descrambled data to the interface circuit 20. If any error remains following the EDC check by the EDC check circuit 31, error correction is performed again on the error-corrected data by the correcting circuit 18a. In this second embodiment of FIG. 17, similar results to those of the embodiment of FIG. 10 can be obtained.

In the embodiment of FIG. 17, an HD-DVD is embodied as the optical disk. However, for example, a DVD-ROM or the like may also be embodied as the optical disk. In this case, it may be desirable to change the capacity of each memory part in accordance with the format of the DVD (refer to FIGS. 1 to 3).

In the embodiment of FIG. 17, the internal configuration of the internal memory portion 12 and the PO syndrome memory portion 17 is embodied by the configuration shown in FIG. 11. However, this configuration is not thereby limited, for example, if it one buffer memory is used for data storage (syndrome storage) and the other buffer memory is used for access (data output), such as at an identical time.

In the above embodiment, each of the buffer memories M1 and M2 of the internal memory portion 12 has the capacity of storing data for two clusters, but the capacity is not particularly so limited. For example, each buffer memory may have the capacity of storing data for one cluster or data for three clusters. Particularly if the optical disk is a DVD-ROM or the like, it may be sufficient that the buffer memory can store data for one cluster.

In such an embodiment, the internal memory portion 12 comprises the two buffer memories M1 and M2, but may also comprise one buffer memory or three or more buffer memories. Moreover, one buffer memory may be configured so that data can simultaneously be stored and read.

The internal memory portion 12 in the above embodiment may also be omitted. In this case, it may be desirable for data also to be input into the PO syndrome generation circuit 16 in the PI direction, and, thus, an intermediate value of a PO syndrome to be stored and read for each byte.

In the above embodiment, each of the buffer memories M3 and M4 of the PO syndrome memory portion 17 may be sized to have a capacity of storing intermediate values of PO syndromes for all columns, but the capacity may not be particularly so limited.

In the above embodiment, the PO syndrome memory part 17 comprises the two buffer memories M3 and M4, but may also comprise one buffer memory or three or more buffer memories. Moreover, one buffer memory may be configured so that data can simultaneously be stored and read.

The PO syndrome memory portion 17 in the above embodiment may be omitted. In this case, it may be desirable to provide PO syndrome computing units for all columns (364 columns in the above embodiment) inside the PO syndrome generation circuit 16.

In the above embodiment, access to the external buffer memory 6 may be prioritized. For example, an arbitration circuit may be provided that determines a priority of access among the descramble circuit 13, the EDC syndrome generation circuit 14, the PI syndrome generation circuit 15, the PO syndrome generation circuit 16, and the error correction circuit 18.

Since the input order of data when generating PO syndromes in the PO syndrome generation circuit 16 in the above embodiment is different from the arrangement order in the ECC block 50, the PO syndrome generation circuit 16 may perform a correction operation to final PO syndromes.

Example embodiments of the present invention have now been described in accordance with the above advantages. It will be appreciated that these examples are merely illustrative of the invention. Many variations and modifications will be apparent to those skilled in the art.

What is claimed:

1. An error correcting device, comprising:
a demodulation circuit configured to read data from a disk and to demodulate the read data to generate demodulated data;
a PI syndrome generation circuit configured to generate a PI syndrome for the demodulated data and to output the PI syndrome to a first memory;
a PO syndrome generation circuit configured to generate a PO syndrome for the demodulated data and to output the PO syndrome to the first memory; and
an error correcting circuit configured to read the output PI syndrome and the output PO syndrome from the first memory and to perform error correction on the demodulated data stored based on the read PI and PO syndromes.

2. The error correcting device according to claim 1, further comprising:
a descramble circuit configured to generate descrambled data by descrambling the demodulated data and to output the descrambled data to one selected from a group of consisting of the first memory and an interface circuit; and
an EDC syndrome generation circuit configured to received the descrambled data and to generate an EDC syndrome from the descrambled data.

3. The error correcting device according to claim 2, wherein the error correcting circuit reads the output PI syndrome, the output PO syndrome, and the generated EDC syndrome from the first memory and performs error correction on the descrambled data stored in the first memory based on the PI, PO and EDC syndromes.

4. The error correcting device according to claim 2, wherein the descramble circuit descrambles the demodulated data which is performed error correction.

5. The error correcting device according to claim 2, further comprising:
an EDC check circuit configured to perform an EDC check based on the descrambled data generated by the descramble circuit.

6. The error correcting device according to claim 1, further comprising:
a PO syndrome memory, logically provided between the PO syndrome generation circuit and the first memory, the PO syndrome memory being configured to store an intermediate result generated when the PO syndrome generation circuit generates the PO syndrome.

7. The error correcting device according to claim 1, further comprising:
a second memory configured to store the demodulated data generated by the demodulation circuit,
wherein the PI syndrome generation circuit or the PO syndrome generation circuit is able to access the second memory.

8. The error correcting device according to claim 7, wherein the second memory stores data for a predetermined number of recording sectors,
wherein the PO syndrome generation circuit outputs an intermediate result for the PO syndrome for each of the predetermined number of recording sectors and stores the intermediate result in a PO syndrome memory.

9. The error correcting device according to claim 7, further comprising:
a third memory either separate from or part of the second memory,
wherein at least one of the second memory or the third memory is used for storing demodulated data from the demodulation circuit and at least one of the second memory and the third memory is accessible by the PI syndrome generation circuit or the PO syndrome generation circuit.

10. The error correcting device according to claim 9,
wherein the disk is an HD-DVD, and wherein the second memory and the third memory store data for two recording sectors of the HD-DVD.

11. The error correcting device according to claim 6, further comprising:
a fourth memory differing from or part of the PO syndrome memory,
wherein at least one of the PO syndrome memory or the fourth memory is used for storing an intermediate result of the PO syndrome and at least one of the PO syndrome memory or the fourth memory is used for outputting the PO syndrome to the first memory.

12. An error correcting method, comprising:
reading data from a disk and demodulating the read data to generate demodulated data;
generating a PI syndrome for the demodulated data and outputting the PI syndrome to a first memory;
generating a PO syndrome of the demodulated data and outputting the PO syndrome to the first memory; and
reading the PI syndrome and the PO syndrome from the first memory and performing error correction on the demodulated data based on the PO and PI syndromes.

13. The error correcting method according to claim 12, further comprising:
generating descrambled data by descrambling the demodulated data; and
generating an EDC syndrome from the descrambled data.

14. The error correcting method according to claim 13, further comprising:
reading the PI syndrome, the PO syndrome, and the EDC syndrome from the first memory; and
performing error correction on the descrambled data stored in the first memory based on the PI, PO, and EDC syndromes.

15. The error correcting method according to claim 12, further comprising:
reading the PI syndrome and the PO syndrome from the first memory; and
performing error correction on the demodulated data stored in the first memory based on the PI and PO syndromes.

16. The error correcting method according to claim 12, further comprising:
storing demodulated data in a second memory; and
using at least one of a portion of the second memory or the third memory for access for generating the PI syndrome or to generate the PO syndrome.

17. The error correcting method according to claim 12, further comprising:
storing an intermediate result of PO syndrome processing in a PO syndrome memory; and
using at least one of a portion of the PO syndrome memory or a fourth memory for outputting the PO syndrome to the first memory.

18. A disk system, comprising:
a disk driving device configured to drive a disk;
a disk control device configured to include an error correcting device that processes data read from the disk; and
a processor configured to receive data from the disk control device,
wherein the error correcting device comprises:
a demodulation circuit configured to read data from a disk and to demodulate the data to generate demodulated data;
a PI syndrome generation circuit configured to generate a PI syndrome for the demodulated data and to output the PI syndrome to a first memory;
a PO syndrome generation circuit configured to generate a PO syndrome for the demodulated data and to output the PO syndrome to the first memory; and
an error correcting circuit configured to read the PI syndrome and the PO syndrome from the first memory and to perform error correction on the demodulated data stored based on the PI and PO syndromes.

19. The disk system according to claim 18, wherein the disk control device comprises:
an input output driving circuit that receives data read from the disk and inputs the data into the error correcting device;
an interface circuit that outputs data from the error correcting device to the computer; and
a control circuit that controls the input output driving circuit and the error correcting device.

20. The disk system according to claim 18, wherein the error correcting device comprises:
a descramble circuit that generates descrambled data by descrambling the modulated data and outputs the descrambled data to one of a group of consisting of the first memory and an interface circuit; and
an EDC syndrome generation circuit that receives the descrambled data and generates an EDC syndrome from the descrambled data.
